(19) United States
(12) Patent Application Publication
(10) Pub. No.: US 2017/0266842 A1
(43) Pub. Date: Sep. 21, 2017

(54) MIXER

(71) Applicant: Liebherr-Mischtechnik GmbH, Bad Schussenried (DE)

(72) Inventor: Gerhard Zenne, Durmetingen (DE)

(21) Appl. No.: 15/450,740

(22) Filed: Mar. 6, 2017

(30) Foreign Application Priority Data
Mar. 21, 2016 (DE) 20 2016 001 859.1

(51) Int. Cl. B28C 5/16; B01F 7/30; B01F 7/16

(52) U.S. Cl. CPC B28C 5/168; B01F 7/165; B01F 7/30; B01F 2215/0047

(57) ABSTRACT

The present invention relates to a mixer, preferably to a ring-pan mixer, having a mixing trough and a mixer rotor that is rotatable via a drive motor about a substantially vertical axis of rotation and at which at least one mixing tool drivable via a separate drive motor is arranged rotatable about a separate axis of rotation, wherein the drive speeds of the mixer rotor and of the at least one mixing tool can be set independently of one another, with the mixer rotor and the at least one mixing tool being able to be set via a transmission independently of one another.

The invention relates to a mixer, preferably to a ring-pan mixer, in accordance with the preamble of claim 1.

A mixer having a mixer rotor is already known from EP 0945170 B1 that is rotatable about a substantially vertical axis of rotation by means of a drive motor and whose mixing tools project into a mixing trough. At least one first mixing tool is coupled to a drive motor via a transmission and is rotatably supported about an axis of rotation in the mixer rotor. At least one second mixing tool is furthermore rotatably supported in the mixer rotor and is coupled to the drive motor via the named transmission. The first and second mixing tools are thus driven together by a single drive motor, wherein a fixed speed difference is predefined via the named operation in accordance with its reduction gear ratio or its gear transmission ratio. In addition, a third mixing tool is rotationally fixedly connected to the mixer rotor and thus has the same speed as the mixer rotor about the vertical axis of rotation. The mixer is used for manufacturing mixtures of liquid, powder and grain components and equally of dry and/or moist mixtures, with the mixed product here in particular comprising concrete mixtures. Due to the speed difference predefined by means of the transmission, the adaptation to the conditions of use, that differ in practice, is not easily possible. Required adaptations are only accompanied by very complex and/or expensive construction changes. The speed of the only drive motor can admittedly be varied during the operation of such a mixer, but the speed difference of the mixing tools remains unchanged.

A mixer of this category having the features of the preamble of claim 1 is already known from EP 22219770 B1. A plurality of electric motors are here known for a separate drive of the mixer. Two transmissions are integrated in a housing to drive the mixer rotor, on the one hand, and the mixing tools, on the other hand. It is disadvantageous with the already known mixer that the two transmissions connected to the drive motors are arranged above the mixing trough and thus in the loading region, whereby poor accessibility and poor cleanability are provided for the mixing trough. In the already known prior art, only one of the rotatable mixing tools is also configured with respect to its speed independently of the mixer rotor.

It is the object of the present invention to provide a mixer of the present category that completely blends the mixed product in the shortest possible time in dependence on the mixing work to obtain a mixing quality that is as high as possible.

This object is achieved in accordance with the invention by the combination of the features of claim 1. For this purpose, a mixer is provided having a mixing trough and a mixer rotor that is rotatable via a drive motor and a substantially vertical axis of rotation and at which at least one mixing tool is arranged rotatable about its own axis of rotation, wherein the drive speeds of the mixer rotor and of the at least one mixing tool can be set independently of one another. In accordance with the invention, the mixer rotor and the at least one mixing tool can be driven via a transmission independently of one another.

This manner of construction allows a very space-saving construction that allows good accessibility to the mixing trough and in particular to its loading region. The two mixing systems that are formed, on the one hand, by the mixer rotor and, on the other hand, by the at least one mixing tool can be driven via the common transmission in a speed-controlled manner independently of one another. The respective transmissions are particularly advantageously formed as rotationally symmetrical. The setting of the different speeds of both the mixer rotor as the main mixer and of the individual mixing tools can be separately controlled during the filling procedure, during dry mixing and during wet mixing as well as during emptying. A very high energy efficiency during mixing and a high efficiency of the mixer can hereby be achieved overall.

Advantageous embodiments of the invention result from the dependent claims following on from the main claim. The mixer rotor is accordingly drivable via a drive shaft configured as a hollow shaft. The hollow shaft advantageously has an outer shaft for driving the mixer rotor and an inner shaft for driving the transmission provided separately for the at least one mixing tool.

Two mixing tools can particularly advantageously be arranged at the mixer rotor that are in turn drivable independently of one another with respect to their drive speeds. Both the mixer rotor and the mixing tools can be drivable via a triple transmission in this case.

The drive motors are particularly advantageously arranged beneath the mixing trough. Good accessibility of the loading region of the mixing pressure is hereby achieved.

The mixing trough advantageously has a ring passage within which the mixing tools are arranged. In this respect, the mixing tools can have a different radius, starting from the hollow shaft, in order thus to obtain an even further improved mixing quality across the diameter of the mixing trough.

In accordance with a further advantageous embodiment of the invention, the speed of the mixer rotor and/or of the at least one mixing tool can be set continuously via at least one frequency converter. In this respect, the speed of the mixer rotor and thus of the main mixing tool can be varied and adapted in a simple manner in dependence on the recipe. A process-controlled setting of the drive speeds of the mixer rotor and of the at least one rotatable mixing tool is therefore possible here.

The direction of rotation of the mixer rotor and of the at least one mixing tool can furthermore each be reversible independently of one another.

Further features, details and advantages of the invention will be explained in more detail with reference to the embodiment shown in the drawing. There are shown:

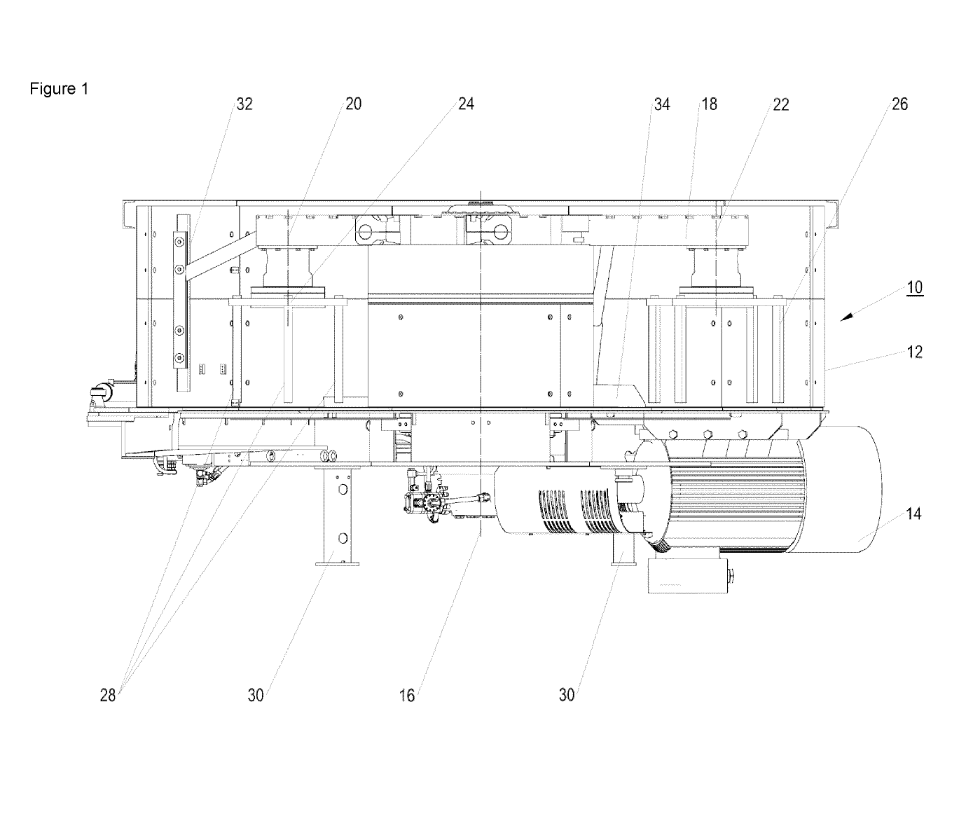

FIG. 1: a sectional representation through a ring-pan mixer in accordance with an embodiment of the present invention;

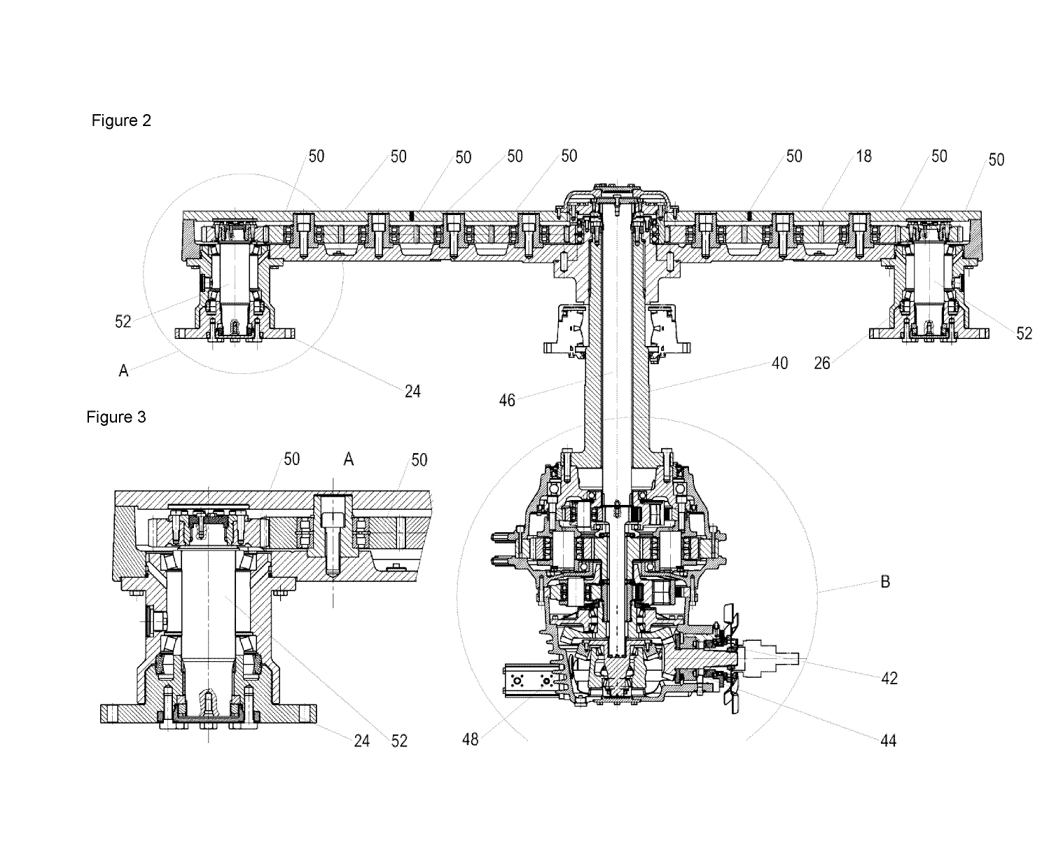

FIG. 2: a sectional representation through a part of the ring-pan mixer in accordance with FIG. 1;

FIG. 3: a detail of the region A of FIG. 2; and

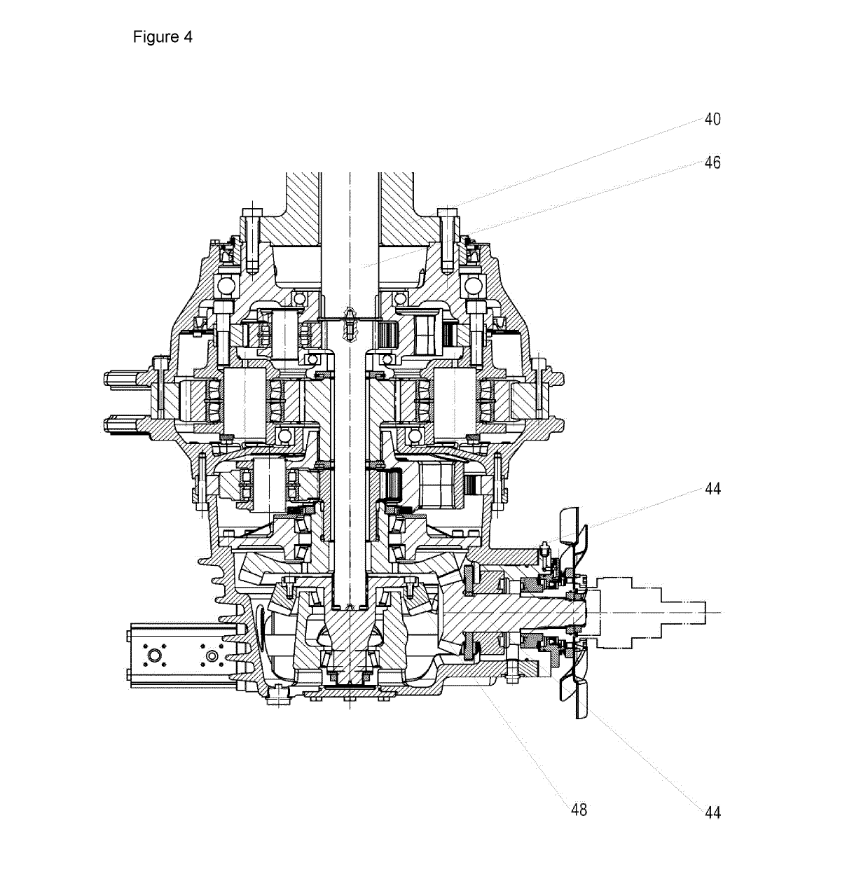

FIG. 4: a detain in accordance with region B of FIG. 2.

A ring mixer in accordance with the invention in the form of a ring-pan mixer 10 is shown in FIG. 1 that has a mixing trough 12 and a mixer rotor 18 drivable via a drive motor 14 in a substantially vertical axis of rotation 16 and two mixer rotors 24 and 26 respectively rotatable about a separate axis of rotation 20 and 22 respectively. The mixer rotors 24 and 26 have a plurality of fingers 28 arranged perpendicular and are also called agitators.

The mixing trough 12 stands on feet 30 and the drive moor 14 for driving the mixer rotor 18 as well as the further drive motor not shown in any more detail here are arranged beneath the mixing trough 12.

The drive motors are connected via a transmission shown in more detail in FIGS. 2 to 4 to the mixer rotor 18, on the one hand, and to the rotatable mixing tools 24 and 26 respectively, on the other hand.

In addition to the rotatable mixing tools 24 and 26, still further mixing tools 32 and 34 are fixedly connected to the mixer rotor 18 and thus rotate at the same speed as the mixer rotor 18. As can be seen from FIG. 1, the different mixing tools 24, 26, 32 and 34 are also each arranged distributed over the diameter of the round mixing trough 12. All the regions of the mixing trough are thus acted on very thoroughly by the mixing tools, whereby the good mixing quality of the mixed product to be mixed is still further improved since dead spaces that are not blended are avoided here.

As can be seen from the representation of FIGS. 2, 3 and 4, the respective drive motors no longer shown there are connected via respective separate drive trains to the mixer rotor 18, on the one hand, and to the rotatable mixing tools 24 and 26, on the other hand. The sectional representation in accordance with FIG. 2 shows the entire transmission in an overview. As is shown here, the transmission is substantially configured as rotationally symmetrical. The mixer rotor 18 is driven via a hollow shaft 40. The hollow shaft 40 has helical gear teeth 42 that form the connection to the drive shaft 44 of the drive motor 14 (not shown in FIG. 2). A shaft 46 is arranged within the hollow shaft 40 and is in rotatable connection via helical gear teeth 48 to a further drive motor, not shown in any more detail here. A series of gears 50 rotatably arranged within the mixer rotor 18 that mesh with one another and that drive the corresponding vertically aligned shafts 52 of the mixing tools 24 and 26 respectively are driven via the inwardly disposed drive shaft 46.

The transmission can be of a very small and compact construction due to the manner of construction so that the mixing trough is easily accessible.

The rotatable mixing tools 24 and 26 used in the present embodiment thus form a twin-agitator system whose speed is continuously adjustable and can be set independently of the main drive. The two drives that are preferably formed as electric motors drive the mixer rotor with its mixing tools fixedly fastened thereto and the so-called agitator system mechanically independently of one another. The advantage results in this respect that an ideal adaptation of the tool speeds is possible in dependence on the progress of the mixing process. The two mixing tools are attached at different distances from the mixer rotor, whereby a fast and ideal blending is ensured in all regions. The agitators effect a perfect cement paste formation in the manufacture of cement. The high achievable agitator speeds effectively prevent clumping. A regulation dependent on the effective motor power is even possible by the use of frequency converters not shown in any more detail in the Figures.

The mixing trough 12 is widely open toward the top and thus allows an ideal material supply as well as unimpeded access to the mixer. This is also in particular due to the fact that the drives are arranged beneath the mixing trough 12.

1. A mixer, preferably a ring-pan mixer, having a mixing trough and a mixer rotor that is rotatable about a substantially vertical axis of rotation via a drive motor and at which at least one mixing tool drivable via a separate drive motor is arranged rotatable about a separate axis of rotation, wherein
the drive speeds of the mixer rotor and of the at least one mixing tool can be set independently of one another, and
the mixer rotor and the at least one mixing tool can be driven independently of one another via a transmission.

2. A mixer in accordance with claim 1, wherein the mixer rotor can be driven via a drive shaft configured as a hollow shaft.

3. A mixer in accordance with claim 2, wherein the hollow shaft has an outer shaft for driving the mixer rotor and an inner shaft for driving a transmission separately provided for the at least one mixing tool.

4. A mixer in accordance with claim 1, wherein two mixing tools are arranged at the mixer rotor that are in turn drivable independently of one another with respect to their drive speeds.

5. A mixer in accordance with claim 4, wherein both the mixer rotor and the mixing tools can be driven via a triple transmission.

6. A mixer in accordance with claim 1, wherein the drive motors are arranged beneath the mixing trough.

7. A mixer in accordance with claim 1, wherein the mixing tools are arranged in the ring passage of the mixing trough.

8. A mixer in accordance with claim 1, wherein the speed of the mixer rotor and/or of the at least one mixing tool is/are continuously adjustable via at least one frequency converter.

9. A mixer in accordance with claim 1, wherein different mixing tools that are adapted to the mixing process are arranged at the mixer rotor.

10. A mixer in accordance with claim 1, wherein at least one mixing tool fixedly connected to the mixer rotor is additionally arranged at the mixer rotor in addition to the at least one rotatable mixing tool.

11. A mixer in accordance with claim 1, wherein the drive speeds of the mixer rotor and of the at least one rotatable mixing tool are adjustable in a process-controlled manner dependent on the mixing job.

12. A mixer in accordance with claim 1, wherein the direction of rotation of the mixer rotor and of the at least one mixing tool is reversible.

13. A mixer in accordance with claim 3, wherein two mixing tools are arranged at the mixer rotor that are in turn drivable independently of one another with respect to their drive speeds.

14. A mixer in accordance with claim 2, wherein two mixing tools are arranged at the mixer rotor that are in turn drivable independently of one another with respect to their drive speeds.

15. A mixer in accordance with claim 14, wherein both the mixer rotor and the mixing tools can be driven via a triple transmission.

16. A mixer in accordance with claim 13, wherein both the mixer rotor and the mixing tools can be driven via a triple transmission.

17. A mixer in accordance with claim 16, wherein the drive motors are arranged beneath the mixing trough.

18. A mixer in accordance with claim 15, wherein the drive motors are arranged beneath the mixing trough.

19. A mixer in accordance with claim 14, wherein the drive motors are arranged beneath the mixing trough.

20. A mixer in accordance with claim 13, wherein the drive motors are arranged beneath the mixing trough.
